(19) United States
(12) Patent Application Publication
(10) Pub. No.: US 2006/0254162 A1
(43) Pub. Date: Nov. 16, 2006

(54) Shim having through openings

(75) Inventor: Gary Workman, Lombard, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Deslauriers, Inc.

(21) Appl. No.: 11/111,277

(22) Filed: Apr. 21, 2005

(51) Int. Cl. E06B 1/04

(52) U.S. Cl. 52/213

(57) ABSTRACT

A shim assembly is adapted to fit in a space between articles to be separated and the space filled with grout. The shim assembly comprises a plurality of elongate one piece bodies of a plurality of different thicknesses. Each one piece body is of a uniform thickness. The bodies have a plurality of bores extending therethrough. Spacing between the bores is uniform.

### FIELD OF THE INVENTION

This invention relates to shims used in construction products and, more particularly, to shims having a plurality of through openings.

### BACKGROUND OF THE INVENTION

In building construction, both commercial and residential, a wall may be constructed of block, brick or stone. There is a need to level these materials. One known procedure for leveling is to use a flat, rectangular plastic shim. A problem arises in that the shim forms a void in the grout when setting the block, brick or stone. This interruption of the bond between layers reduces the overall strength of the structure. Another unintended consequence of such a void is the creation of an opening in which wind driven rain can enter the structure. The resultant moisture can create a number of unsafe conditions, such as mold, interior leakage, etc.

A similar situation can occur during grouting in place of metal doors, glass block and windows. The frames are drilled to permit grout to be pumped into place. Since solid shims are typically used, blockages are formed in the frames. These blockages require additional fill holes to be made to allow for completion of the grouting.

The present invention is directed to solving one or more of the problems discussed above in a novel and simple manner.

### SUMMARY OF THE INVENTION

In accordance with the invention, there is provided a shim having a plurality of bores.

Broadly, there is disclosed herein a shim used to fill in space between articles comprising an elongate one piece body of uniform thickness. The body has a plurality of bores extending therethrough. Spacing between the bores is uniform.

It is a feature of the invention that the body is generally U-shaped.

There is disclosed in accordance with another aspect of the invention a shim adapted to fit in a space between articles to be separated and the space filled with grout. The shim comprises an elongate one piece body of uniform thickness. The body has a plurality of bores extending therethrough. Spacing between the bores is uniform.

It is a feature of the invention that the bores are of uniform size.

It is another feature of the invention that the bores are configured in groups of three equally and longitudinally spaced apart bores and the groups are equally spaced apart. The body may be generally U-shaped having opposite legs connected by a central portion and one of the groups of bores is located in the central portion.

It is additional feature of the invention that the shim is constructed of plastic.

It is still another feature of the invention to provide a plurality of counterbores in the body wherein each of the bores extend through one of the counterbores. The counterbores may comprise elongate counterbores wherein a plurality of the bores extend through the elongate counterbores.

There is disclosed in accordance with another aspect of the invention a shim assembly adapted to fit in a space between articles to be separated and the space filled with grout. The shim assembly comprises a plurality of elongate one piece bodies of a plurality of different thicknesses. Each one piece body is of a uniform thickness. The bodies have a plurality of bores extending therethrough. Spacing between the bores is uniform.

It is a feature of the invention to provide a connector receivable in one of the bores to support the body on an article.

It is yet another feature of the invention to provide a connector receivable in aligned bores of each of the bodies to retain the bodies in alignment.

Further features and advantages of the invention will be readily apparent from the specification and from the drawings.

### BRIEF DESCRIPTION OF THE DRAWINGS

FIG. 1 is an exploded perspective view of a shim assembly in accordance with the invention;

FIG. 2 is a partial perspective view illustrating use of a shim in accordance with the invention in a block wall;

FIG. 3 is a sectional view taken along the line 3-3 of FIG. 2;

FIG. 4 is a partial perspective view illustrating use of the shim assembly in a frame construction;

FIG. 5 is a partial perspective view illustrating use of the shim in accordance with the invention as a spacer; and

FIG. 6 is a side elevation view of use of a plurality of shims in accordance with the invention as a spacer.

### DETAILED DESCRIPTION OF THE INVENTION

The present invention relates to a shim assembly adapted for use in building construction and using shim pieces having a plurality of uniformly sized, shaped and spaced bores.

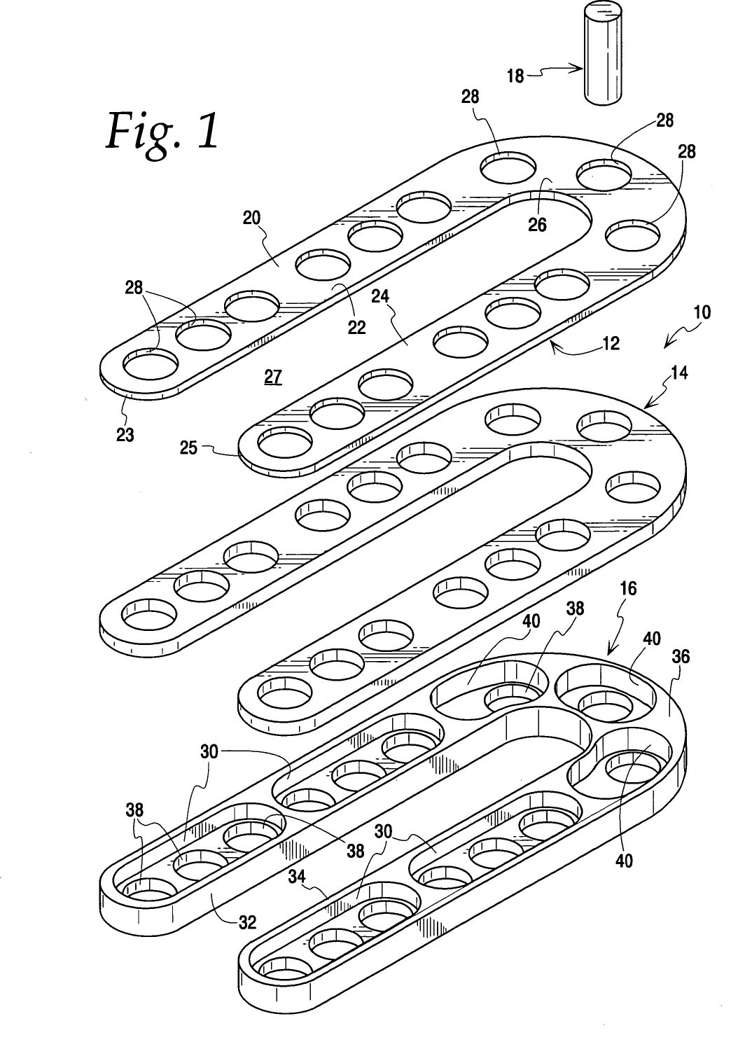

Referring to FIG. 1, a shim assembly 10 in accordance with the invention comprises a first shim 12, a second shim 14, a third shim 16 and a connector 18.

The first shim 12 comprises a one piece body 20. The body 20 comprises opposite legs 22 and 24 connected at one end by a connecting portion 26 so that the body 20 is generally U-shaped. As such, the body 20 is elongate, from a distal end 23 of the leg 22 to a distal end 25 of the other leg 24, and turned, or elongate from the distal ends 23 and 25 to the connecting portion 26 with a void 27 between the legs 22 and 24. A plurality of through openings or bores 28 extend through the body 20. The bores 28 are circular and are of uniform size. The bores 28 are provided in groups of three. Spacing between adjacent bores 28 of each group are substantially equal. Spacing between adjacent groups is such that, if desired, an additional bore could be placed between groups to provide equal spacing between each adjacent bore. As such, there are two groups of three bores 28 in each leg 22 and 24 and one group of three bores 28 in the connecting portion 26. The bores 28 in the one leg 22 are aligned with the bores 28 in the other leg 24.

In an illustrated embodiment of the invention, the body 22 is about 3.5″ in overall length and about 1.5″ wide. The width of each leg 22 and 24 and the connecting portion 26 is about ½″ so that the legs 22 and 24 are spaced apart about ½″ in the void 27. The body 20 has a uniform thickness on the order of 1/16″. The bores 28 are about 3/16″ in diameter, with center-center spacing of about 5/16″

The second shim 14 is substantially identical to the first shim 12. Therefore, it will not be described in detail. The second shim 14 differs from the first shim 12 in having a thickness of about ⅛″. Similarly, the third shim 16 is generally similar to the first shim 12, except that it has a thickness of about ¼″. Additionally, the third shim 16 includes a pair of elongate counterbores 30 in each leg 32 and 34. Each elongate counterbore 30 includes a group of bores 38. Each bore 38 in a connecting portion 36 includes an individual counterbore 40. The counterbores 30 and 40 reduce use of material in the third shim 16 and also provide additional spaces to be filled with grout, as described below.

In accordance with the invention, each of the shims 12, 14 and 16 is of molded plastic construction. The connector 18 comprises a dowel or the like of a size to be frictionally received in any of the openings 28 or 38. As such, the connector 18 can be fit into a bore 28 or 38 of any of the shims 12, 14 or 16 to act as a support. Alternatively, a plurality of shims 12, 14 and/or 16 can be stacked in alignment with one or more of the connectors 18 fitting through aligned bores 28 and 38 to retain the shim assembly 10 in alignment.

In accordance with the invention, the individual shims 12, 14 and 16 can be stacked in any combination to achieve a desired thickness. For example, for a thickness of ⅛″, the second shim 14 can be used by itself, or two of the first shims 12 can be stacked together. ⅜″ thickness is provided by stacking the first shim 12 and the second shim 14. Numerous other combinations are possible, as will be apparent to those skilled in the art. As such, the individual shims 12, 14 and 16 can be provided individually or as an assembly or kit including any number of quantities of each individual size, as will be apparent. Moreover, in accordance with the invention, the shims 12, 14 and 16 could be other shapes, such as rectangular, and of different wall thicknesses.

Use of the shim assembly 10 and/or the individual shims 12, 14 and 16 is described in the following figures.

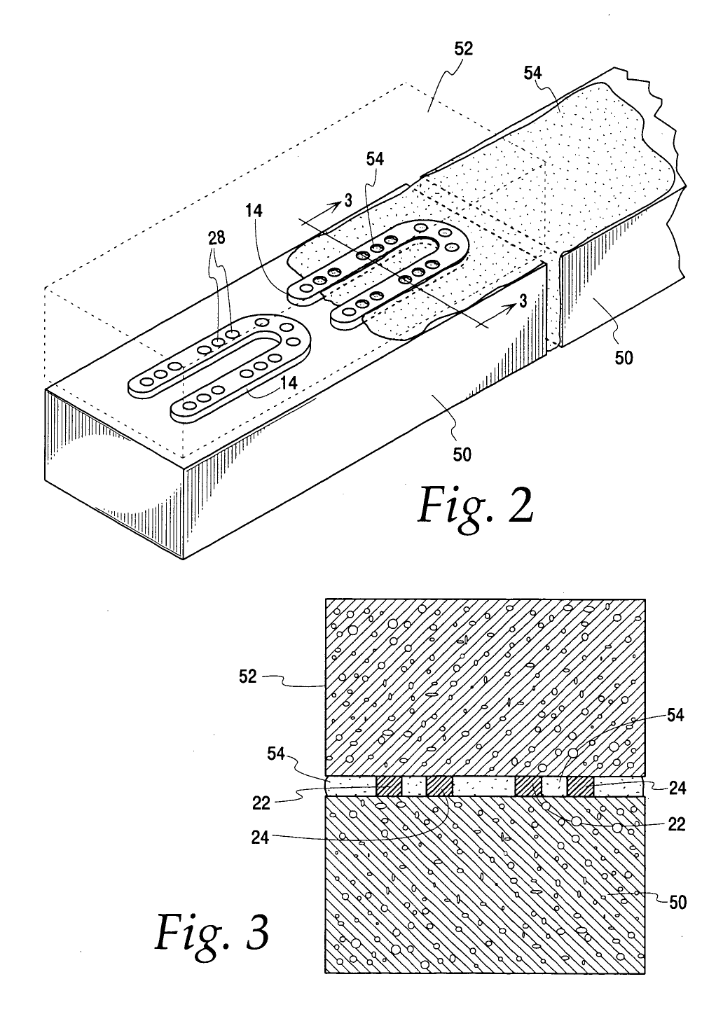

Referring initially to FIGS. 2 and 3, the second shim 14 is illustrated used in a block wall construction comprising lower blocks 50 and an upper block 52. Two of the second shims 14 are placed atop one of the lower blocks 50. A layer of grout 54 is then placed atop and in between the lower blocks 50, including surrounding the second shims 14. The upper block 52 is then placed atop the grout layer 54. As is apparent, grout 54 passes through the bores 28, as shown, and improves the bond between the lower blocks 50 and upper blocks 52. This maintains structural integrity of the structure and reduces the extent of a void being formed which could permit moisture to enter the structure.

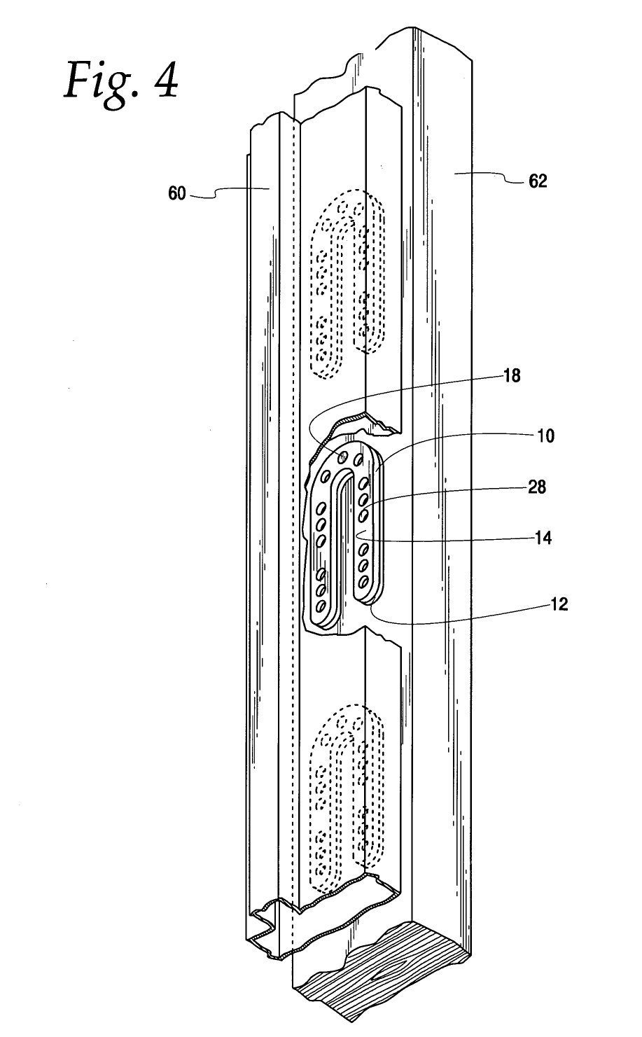

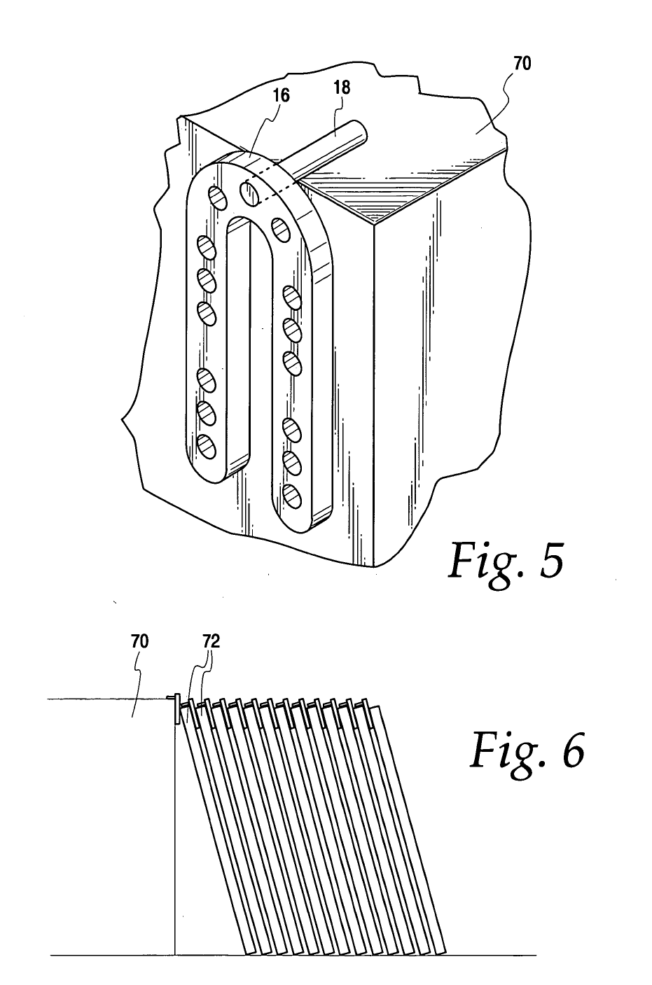

Referring to FIG. 4, a hollow metal frame 60 is mounted adjacent a wall 62, with shim assemblies 10 providing appropriate spacing. In this embodiment, the shim assembly 10 comprises a first shim 12 and a second shim 14 held together with a connector 18. The connector 18 may extend into the wall 62 to maintain it in place. Alternatively, the shim assembly 10, owing to its U-shape, could hang on fasteners or the like already in place. As is well known, the frames 60 are drilled to permit grout to be pumped into place. The use of the shim assembly 10 with bores 28 permit grout to flow through the bores 28, minimizing the number of holes to be made in the frames and labor required to complete the grouting and finish the repair to the frames.

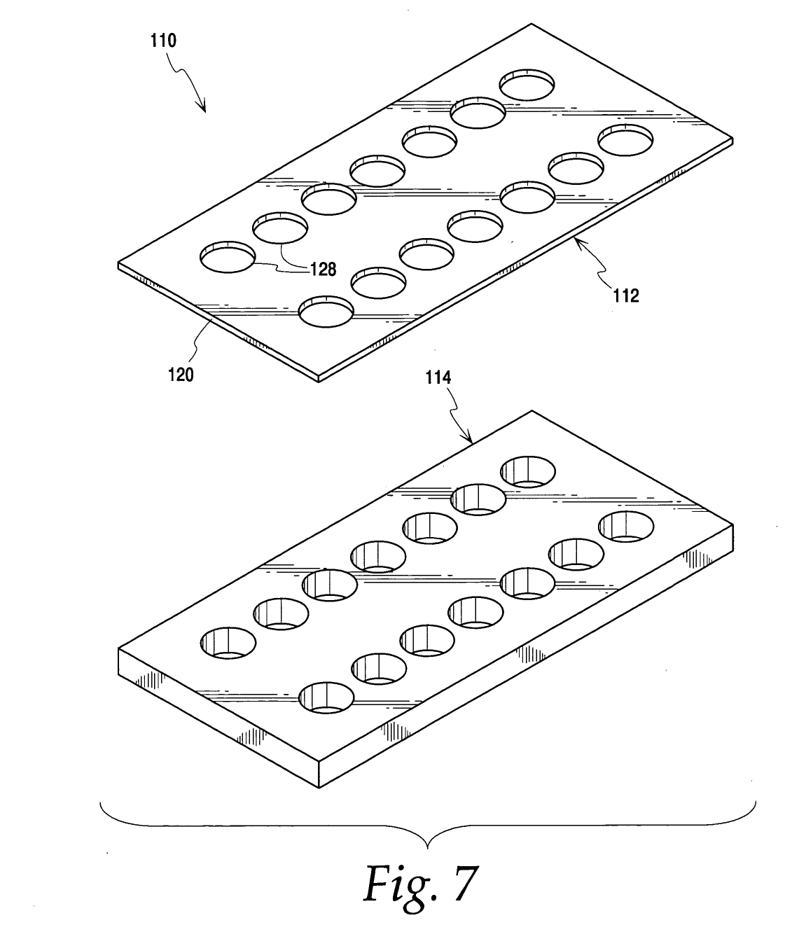

Referring to FIGS. 5 and 6, a further use of the shim assembly 10 is illustrated. Pre-cast producers use shims for installation of panels but use special panel pads for storage and shipping. Such pads have “bumps” to permit air flow to prevent discoloring of concrete in the pre-cast panels. In accordance with the invention, one of the shims, such as the third shim 16, can be used with the connector 18 through one of the openings 28 to hang the shim 16 from a wall 70, as shown in FIG. 4. This can be used to provide a spacer between the wall 70 and a pre-cast panel 72, as shown in FIG. 6. Thereafter, additional such assemblies formed by a connector 18 and any of the shims 12, 14 and 16, can be used to separate additional panels 72, as illustrated. The bores 28 or 38 in the shim 12, 14 and 16, permit air flow. As such, the shim assembly 10 can also be used as panel pads, eliminating the need to carry separate products.

In accordance with the invention, uniform size holes enable installers to secure shims as needed with a pin or dowel, such as the connector 18, which can extend out from the shims. This pin extension allows for accurate shim height and depth to be achieved along with the ability to be used as a hanger pad, as described above. Uniform holes also offer the opportunity for all users to preassemble shims into specific thicknesses by inserting a pin or dowel, such as the connector 18, through the bores 28 and/or 38, as described and illustrated above. Uniform bores 28 and 38 provide the ability and benefit of using the bores to secure the shims 12, 14 and 16 in place without pre-drilling. By installing shims 12, 14 and/or 16 at various points along a wall of block or brick, the shims allow a leveling string to be inserted through the holes and between the shims to aid in the laying of the brick, and/or block, plum, level and squarely. Finally, the bores 28 and 38 provide a convenient and easy precise snap-off or break-off point to adjust for length.

Referring to FIG. 7, a shim assembly 110 in accordance with an alternative embodiment of the invention comprises a first shim 112 and a second shim 114. The shims 112 and 114 are generally similar to the shims 12 and 14, discussed above, except being of rectangular construction. Particularly, the first shim 112 comprises a generally rectangular one piece body 120. A plurality of rows of through openings or bores 128 extend through the body 120. Spacing between adjacent bores 128 in each row are substantially equal. As is apparent, additional rows of bores 128 could be provided. The bores in each row are aligned. In the illustrated embodiment of the invention, the thickness of the first s him 112 is about ⅙″. The thickness of the second shim 114 is about ⅛″. Other thicknesses, such as ¼″ or the like, could also be provided. The shims 112 and 114 are of molded plastic construction. A connector such as the connector 18, see FIG. 1, can be used. The shim assembly 110 can be used similarly to the shim assembly 10, discussed above.

In the illustrated embodiments of the invention, the bores or through openings are circular. Alternatively, they could have other shapes, such as square, octagon or the like.

Thus, in accordance with the invention, there is provided a shim having a plurality of uniformly spaced bores therethrough.

I claim:

1. A shim used to fill in space between articles comprising an elongate one piece body of uniform thickness, the body having a plurality of bores extending therethrough, spacing between the bores being uniform.

2. The shim of claim 1 wherein the body is generally U-shaped.

3. A shim adapted to fit in a space between articles to be separated and the space filled with grout, comprising an elongate one piece body of uniform thickness, the body having a plurality of bores extending therethrough, spacing between the bores being uniform.

4. The shim of claim 3 wherein the body is generally U-shaped.

5. The shim of claim 3 wherein the bores are of a uniform size.

6. The shim of claim 3 wherein the bore are configured in groups of three equally longitudinally spaced apart bores and the groups are equally spaced apart.

7. The shim of claim 3 wherein the shim is constructed of plastic.

8. The shim of claim 6 wherein the body is generally U-shaped having opposite legs connected by a central portion and one of the groups of bores is located in the central portion.

9. The shim of claim 6 further comprising a plurality of counterbores in the body and wherein each of said bores extends through one of the counterbores.

10. The shim of claim 9 wherein said counterbores comprise elongate counterbores wherein a plurality of said bores extend through said elongate counterbores.

11. A shim assembly adapted to fit in a space between articles to be separated and the space filled with grout, comprising a plurality of elongate one piece bodies of a plurality of different thicknesses, wherein each one piece body is of a uniform thickness, the bodies having a plurality of bores extending therethrough, spacing between the bores being uniform.

12. The shim assembly of claim 11 wherein each body is generally U-shaped.

13. The shim assembly of claim 11 wherein the bores are of a uniform size.

14. The shim assembly of claim 11 wherein the bores in each body are configured in groups of three equally longitudinally spaced apart bores and the groups are equally spaced apart.

15. The shim assembly of claim 11 wherein the bodies are constructed of plastic.

16. The shim assembly of claim 14 wherein the bodies are generally U-shaped having opposite legs connected by a central portion and one of the groups of bores is located in the central portion.

17. The shim assembly of claim 14 wherein a thicker one of the bodies comprises a plurality of counterbores in the body and wherein each bore of the thicker one of the bodies extends through one of the counterbores.

18. The shim assembly of claim 17 wherein said counterbores comprise elongate counterbores wherein a plurality of said bores extend through said elongate counterbores.

19. The shim assembly of claim 11 further comprising a connecter receivable in one of the bores to support the body on an article.

20. The shim assembly of claim 11 further comprising a connecter receivable in aligned bores of each of the bodies to retain the bodies in alignment.
